(19) United States
(12) Patent Application Publication
(10) Pub. No.: US 2016/0120012 A1
(43) Pub. Date: Apr. 28, 2016

(54) X-RAY SOURCE AND METHOD FOR PRODUCING X-RAYS

(71) Applicant: SIEMENS AKTIENGESELLSCHAFT, München (DE)

(72) Inventor: Oliver Heid, Erlangen (DE)

(21) Appl. No.: 14/892,472

(22) PCT Filed: Mar. 4, 2014
(86) PCT No.: PCT/EP2014/054124

§ 371 Date: Jan. 6, 2016

(30) Foreign Application Priority Data
May 22, 2013 (DE) 10 2013 209 447.7

(51) Int. Cl. H05G 2/00; H01J 35/08

(52) U.S. Cl. CPC H05G 2/008; H01J 35/08; H01J 2235/082

(57) ABSTRACT

An X-ray source is provided, the X-ray source including an outer housing that may be evacuated, including at least one radiation exit window, an electron source for emitting an electron beam, and an anode for producing X-rays. When the X-ray source is in operation, the anode is present in a vapor phase, wherein the vaporous anode may be produced by evaporating a stock of anode material present in a condensed phase by exposure to the electron beam. A method for producing X-rays is also provided, in which inside of an outer housing of an X-ray, which may be evacuated, a vaporous anode is continuously formed by bombarding the anode material that is present in a condensed phase with an electron beam. The vaporous anode emits X-rays by interaction with the electron beam.

The present patent document is a §371 nationalization of PCT Application Serial Number PCT/EP2014/054124, filed Mar. 4, 2014, designating the United States, which is hereby incorporated by reference, and this patent document also claims the benefit of DE 10 2013 209 447.7, filed May 22, 2013, which is also hereby incorporated by reference.

### TECHNICAL FIELD

Present embodiments relate to an X-ray source having an outer housing that may be evacuated, including at least one radiation exit window that allows X-rays to pass through, an electron source for emitting an electron beam, and an anode for producing X-rays. Embodiments furthermore relate to a method for producing X-rays, in which an anode emits X-rays by interaction with an electron beam.

### BACKGROUND

In known X-ray sources, inside an outer housing that may be evacuated, also known as an X-ray tube, electrons are accelerated onto an anode, the material of which is suitable for converting energy of the accelerated electrons into X-rays. The X-rays are coupled out of the X-ray source by way of an exit window that allows X-rays to pass through. When used in an imaging system, the radiation may be aimed at an object to be examined and subsequently measured using an imaging X-ray detector. Such systems are widely used, especially in medical imaging. For the diagnostic examination of human body parts, it may be desired to achieve the highest possible image quality at the lowest possible X-ray dose. To this end, X-rays that are as monochromatic as possible are advantageous, where the radiation includes substantially of characteristic X-rays and only a smallest portion includes the bremsstrahlung that is distributed over a wide energy range.

U.S. Pat. No. 7,436,931 B2 describes an X-ray source for producing monochromatic X-rays. Here, a very thin anode is used which is mounted on an anode carrier made of a material having a low atomic number.

Due to the anode layer, substantially characteristic X-rays within a narrow energy range are produced as a result. In addition, owing to the low layer thickness of the anode and to the low atomic number of the carrier, little bremsstrahlung is emitted, such that only a small proportion of broadband X-rays are produced by the source. One disadvantage of the solution disclosed here is the high heat that develops in the anode layer and in the anode carrier. The heat that develops in the anode, in the case of such X-ray sources, may be limiting for the power density of the electron beam and thus also for the radiation power emitted by the X-ray source. Another disadvantage is the low mechanical strength and the associated high wear of the thin anode layer.

### SUMMARY AND DESCRIPTION

The scope of the present invention is defined solely by the appended claims and is not affected to any degree by the statements within this summary. The present embodiments may obviate one or more of the drawbacks or limitations in the related art.

It is an object of the embodiments to specify an X-ray source for producing X-rays that are as monochromatic as possible, which avoids the stated disadvantages. It is another object of the embodiments to specify a method for producing X-rays.

The X-ray source includes an outer housing that may be evacuated, including at least one radiation exit window that allows X-rays to pass through, an electron source for emitting an electron beam, and an anode for producing X-rays. When the X-ray source is in operation, the anode is present in a vapor phase, wherein the vaporous anode may be produced by evaporating a supply of anode material that is present in a condensed phase by exposing it to the electron beam.

The X-ray source enables X-rays having a high proportion of substantially monochromatic characteristic radiation to be produced through the use of a vaporous anode. The dynamic production of a vaporous anode directly in the electron beam makes the vapor anode used therefor available directly at the location of use. Since the anode is present in vaporous form, the anode material is automatically provided in the low material amount that is beneficial for producing monochromatic radiation. Owing to the small amount of material that is provided for the interaction, only a small proportion of broadband bremsstrahlung and a high proportion of monochromatic, characteristic X-rays are produced.

The X-ray source furthermore enables the operation at particularly high power densities of the electron beam, since the vaporous anode is continuously formed anew through evaporation of anode material from a material supply. As a result, no problems caused by material wear occur. In addition, no special measures for heat removal from the anode are necessary, since the heat resulting from interaction with the electron beam in the vapor anode is continuously removed by diffusion and a flow of the vapor away from the location where the X-rays are produced. It is thus possible to use an electron beam having a substantially higher power density than in the case of X-ray sources having a solid anode layer. Even if quickly turning anodes are used, also known as rotating anodes, the heat removal from the anode layer in the region of the interaction with the electron beam represents a limiting factor for the overall radiation power of conventional X-ray sources.

The use of an electron beam with high output is particularly important especially for producing monochromatic X-rays, since in the case where an interaction takes place with a small amount of anode material, only a small proportion of the electron radiation power may be converted to X-rays. In order to achieve the minimum radiation power necessary for various imaging methods, it is thus necessary for the power of the used electron beam to still be significantly higher than when using conventional solid anodes with greater layer thicknesses and greater conversion proportion. In addition to the high absolute power of the electron beam, a high power density of the electron beam at the location of the interaction with the anode material is likewise important. If the electron beam may be focused onto a very small region with a correspondingly high power density, it is possible to produce X-rays very well defined spatially and with which the recording of X-ray images with a particularly high spatial resolution is possible.

In the method, a vaporous anode is continuously formed within an outer housing of an X-ray source that may be evacuated by bombarding anode material that is present in the condensed phase with an electron beam. The vaporous anode emits X-rays due to interaction with the electron beam. The advantages of the method for producing X-rays are analogous to the advantages of the X-ray source.

Advantageous embodiments and developments of the X-ray source may have the following features.

The X-ray source may include a feed apparatus for feeding anode material that is present in a condensed phase from an anode supply into an interaction zone in the region of the electron beam. By way of this embodiment, the anode material may be made available continuously for evaporation in the electron beam, with the result that new material for evaporation in the electron beam is constantly available. It is thus also possible to constantly form new vaporous anode material in the interaction zone, with the result that a sufficiently high vapor density in this zone is constantly provided. The interaction zone is defined by the spatial overlap of the electron beam with the vapor cloud that has formed. The width of the interaction zone is thus defined in a direction perpendicular to an axis of the electron beam by the lateral extent of the electron beam itself. The extent of the interaction zone along the axis of the electron beam is defined by the width of the feed region and the form and size of the resulting vapor cloud. It is expedient if the width of the interaction zone is similar in different spatial directions. The lateral extent of the electron beam and the effective width of the feed region may be in each case below 500 μm or below 250 μm.

The feed apparatus may be configured such that anode material may be catapulted into the interaction zone of the electron beam. In this embodiment, the feed region is thus a trajectory on which anode material is ballistically introduced into the interaction zone. The introduction of small portions of material into the interaction zone facilitates the complete evaporation of the portions in the electron beam and causes at most a small residual proportion of non-evaporated anode material to be present in the interaction zone during the production of the X-rays.

The X-ray source may in particular be configured such that the anode material may be catapulted into the interaction zone in the form of a portioned solid. By way of example, the solid may be introduced into the interaction zone in the form of a powder jet through a nozzle. Alternatively, the solid may also be bombarded into the electron beam in pulsed fashion in the form of grains or other individual particles. The anode material that is present in solid form may include metallic materials, and may include materials having an atomic number of at least 40. Particularly suitable materials are molybdenum having an atomic number of 42 and tungsten having an atomic number of 74. Such a heavy metallic material may also be present in an alloy with other metals, as oxidic material, as a salt or as another chemical compound. The anode particles may also be present, for example, in the form of a porous solid, in particular in the form of an aerogel.

Alternatively, the X-ray source may be configured such that anode material may be catapulted into the interaction zone in the form of liquid droplets. Here, too, the anode material may include the abovementioned metallic materials, in particular metallic materials having an atomic number of at least 40. The anode material also advantageously includes other materials that are liquid at room temperature or at slightly raised temperatures. For example, the anode material may be an alloy with a low melting point, or solid metallic particles may also be present dispersed in another liquid. The anode material in this embodiment may be catapulted into the interaction zone in portions in the form of small drops. The feed apparatus may, for example, include a nozzle that feeds the anode material into the interaction zone in the form of a finely sprayed mist or in regular individual droplets. This nozzle may be configured similar to the nozzle of an inkjet printer, for example.

The anode material may be fed continuously or in pulses, where in the case of pulsed feeding the frequency may be, for example, in a range of above 1 kHz or in a range of above 10 kHz. Pulsed feeding thus makes possible quasi continuous operation of the X-ray source. The electron beam of the X-ray source may also be operated in pulsed or continuous fashion. In the case of pulsed operation, the synchronization of pulses of the electron beam with pulses of the material feed is advantageous.

A vapor vessel, which during the operation of the X-ray source at least partially encloses the vaporous anode, may be arranged within the outer housing that may be evacuated. The advantage of this embodiment is that the vapor vessel makes possible a spatial separation of a region around the interaction zone that has a relatively higher vapor density from an outer region that has a better vacuum. Expediently, the electron source is arranged outside the vapor vessel such that the electron source is located in a region with a better vacuum. The region between the outer housing and the vapor vessel may be evacuated continuously using a vacuum pump. Alternatively or additionally, it is also possible for the region within the vapor vessel to be pumped to empty using a vacuum line in order to remove the amount of anode material that is continuously fed in. The X-ray source may also include a cooling apparatus with which the vapor housing may be cooled to a temperature of for example 30 degrees Celsius or lower. The anode material may then condense at the wall of the vapor housing and is thus continuously removed from the internal space of the housing, with the result that it is still possible for a relatively good vacuum to be maintained between the vapor housing and the outer housing. The forming of the vacuum is necessary to provide the operation of the electron source and acceleration and a relatively smooth transport of the electrons along a central beam direction. The pressure inside the vapor vessel is, on average, not too high, since otherwise the transport of the electron beam into the interaction zone is made more difficult. In the case of a continuous removal of the anode material by way of pumping out and/or condensation at the vessel walls, it is advantageously possible to achieve an equalization state in which, in the center of the interaction zone, a relatively high vapor density may be at least 0.01 bar, or at least 0.1 bar, and in which the vapor density starting from this center decreases approximately quadratically with the radial distance.

The electron source and the supply of anode material may be part of an electric circuit, wherein the electron source may be at a negative potential relative to the anode supply during the operation of the X-ray source. Such a potential difference enables the acceleration of electrons released by the electron source in the direction of the anode material. It is presumed here that anode particles and/or anode droplets that are fed in from the anode supply and a vapor cloud that is produced therefrom by evaporation also retain an electric potential that is near the potential of the anode supply. During the operation of the X-ray source, the electric potential of the vaporous anode may in particular also be lower than the electric potential of the electron source, with the result that the released electrons are accelerated in the direction of the vaporous anode. In addition, the X-ray source may also include a focusing unit. The focusing unit includes, for example, one or more control electrodes that may be arranged around the interaction zone in the form of a cup segment. Such a focusing unit is used to bundle the electron beam such that it has the lowest possible lateral extent in the region of the interaction zone.

The X-ray source may include a collector for collecting electrons that pass through the vaporous anode, wherein the collector is at a negative potential relative to a supply of anode material during the operation of the X-ray source. As a result, the potential of the collector is also negative relative to the vaporous anode that is formed therefrom. The collector is expediently arranged behind the vaporous anode in the electron beam direction, such that the electrons passing through the anode decelerate along their continued path toward the collector. The electric potential of the collector may lie between the potential of the electron source and the potential of the anode supply, with the result that the electrons lose only some of their kinetic energy on their way from the vapor anode to the collector. The advantage of this embodiment is that the energetic efficiency of the X-ray source is increased, since a proportion of the kinetic energy of the electrons is returned to the electric field. This aspect is particularly important if a vaporous anode is used, since the efficiency of the conversion of electrical energy into X-rays with a low density of anode material tends to be low. This makes the recovery of non-converted energy of the non-interacting electrons even more important. Another advantage of this embodiment is that, owing to the deceleration of the electrons, any further interaction of highly energetic electrons in other materials is avoided such that the production of additional bremsstrahlung is suppressed, which contributes to an improvement of the monochromatic properties of the X-ray source.

The collector may have a thicker configuration along the electron beam direction than the average penetration depth of the electrons at a kinetic energy of the electrons of 150 keV. The maximum kinetic energy to which the electrons are accelerated in X-ray sources is, in many X-ray sources, in the range of up to 150 keV. If the collector is configured such that it is thicker in the range of the electron energy than the average penetration depth of the electrons, a significant proportion of the electrons having this maximum energy will be captured by the collector during the operation of the X-ray source. If the collector is also, as intended, brought to a negative potential during operation, the electrons are decelerated before entry into the material of the collector, and accordingly, an even greater proportion of the electrons is captured by the collector. The proportion of the electrons captured by the collector in this embodiment is at least 1-1/e and thus more than 63%.

The material of the described collector may include an electrically conductive material, for example, stainless steel and/or copper. The collector may have a thickness of at least 1 mm along the electron beam direction.

The collector may have a depression in the electron beam direction. Such a depression is advantageous for reliably capturing the accelerated electrons in the collector and preventing lateral escape of the electrons toward the outer housing of the X-ray source. The configuration of a depression in the collector is expedient since a certain proportion of the electrons are scattered at the anode and thus have their flight direction changed. A collector having a depression is particularly suitable for capturing as many scattered electrons as possible.

The described depression may have a trapezoidal configuration. Alternatively, the depression may also be in the form of a rectangle, a U or a semicircle. It may have a depth of at least 1 cm, particularly advantageously the depth may be between 5 cm and 15 cm.

The X-ray source may include at least one deflection unit for deflecting the electron beam onto a curved electron path. In particular, the electron beam may be curved between the electron source and the interaction zone. Such an arrangement is advantageous especially if a vapor vessel is present, because in that case the electron source may be positioned such that it is not located in an expansion direction of the vapor that is directly accessible from the interaction zone. The vapor vessel is expediently provided with an opening for inputting the electron beam. The electron source may be arranged, for example, with an offset such that it is located next to a direct connection axis between this entry opening and the interaction zone. The deflection unit of this embodiment may include, for example, a magnetic coil and/or an electrostatic deflection unit, for example in the form of a curved shielding tube. Although this embodiment does not completely avoid the impingement of vaporous anode material on the electron source, the properties of the flow expansion for Knudsen flow or Prandtl-Meyer corner flow at least strongly reduce the expansion of the vapor along non-rectilinear paths.

Advantageous configurations and developments of the method may have the following features.

The anode material that is present in the condensed phase may be catapulted into an interaction zone of the electron beam using a feed apparatus.

The anode material may be fed into the interaction zone in the form of a solid in portions.

The anode material may be fed into the interaction zone in the form of liquid droplets.

A vapor housing located inside the outer housing that may be evacuated and at least partially surrounds the vaporous anode may be cooled to a temperature of at most 100 degrees Celsius. This embodiment permits continuous removal of the vaporous anode from the vapor vessel, which permits maintenance of a better vacuum in the region between the outer housing and the vapor vessel and obtaining a lower average vapor density in the interior of the vapor vessel.

After the electron beam passes through the vaporous anode, it may be decelerated and captured by a collector, which is kept at a negative potential relative to the anode material.

The method may further include outputting the X-rays through a radiation output window that is intended herefor.

### BRIEF DESCRIPTION OF THE DRAWINGS

FIG. 1 illustrates a schematic cross section of an X-ray source according to a first exemplary embodiment.

FIG. 2 illustrates a schematic cross section of an X-ray source according to a second exemplary embodiment.

Mutually corresponding elements are provided with identical reference signs in the figures.

### DETAILED DESCRIPTION

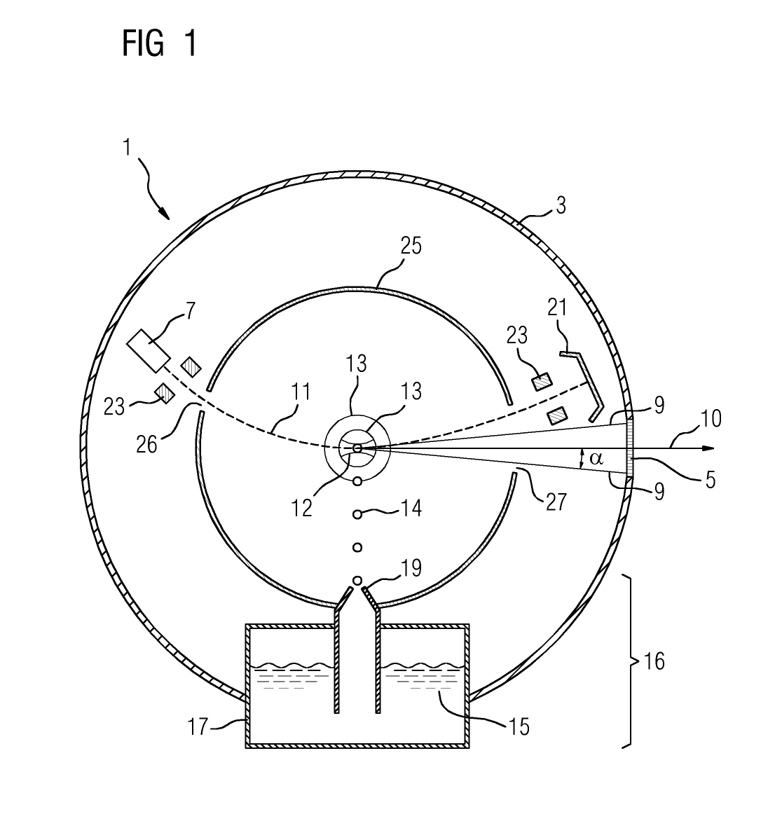

A schematic cross section of an X-ray source 1 according to a first exemplary embodiment is illustrated in FIG. 1. Illustrated is an outer housing 3 that may be evacuated and has a circular cross section. The outer housing 3 may be formed, for example, as a hollow sphere or as a hollow cylinder. The production of a vacuum inside the housing 3 is a prerequisite for the emission of electrons into this space and their acceleration in the direction of a specific location. The outer housing 3 is provided with a beam exit window 5 that is used to output the X-rays 9 produced from the X-ray source 1. The beam exit window 5 is also sealed in a vacuum-tight manner with respect to the outer housing 3. Suitable materials for the beam exit window 5 are, for example, beryllium or aluminum.

Within the space that may be evacuated, an electron source 7, a vapor vessel 25 having an entry opening 26 and an exit opening 27 and a collector 21 are arranged. The electron source 7 is used to produce an electron beam that is accelerated along a central electron flight path 11. The electron source 7 may be a field emission cathode or a hot cathode. A field emission cathode is also known as a cold cathode, in which electrons may be emitted through a very high local field into the evacuated space of the X-ray source. In contrast, in a hot cathode, the electrons are emitted into the evacuated space from the cathode material under the influence of a high temperature.

Arranged below the vapor vessel 25 is a feed apparatus 16, by way of which anode material in the form of droplets 14 may be fed through a nozzle 19 into the interior of the vapor vessel 25. The anode material is in a supply container 17 in the form of a liquid anode supply 15. The droplets 14 are injected in pulsed fashion in regular intervals through the nozzle 19 in the direction of the center of the vapor vessel 25. The diameter of the droplets may be, for example, between 5 and 20 μm. The anode material is fed in such that the stream of material intersects the central electron flight path 11. The anode material evaporates in the region of the intersection due to the influence of the electron beam. This produces a vapor cloud 13, which is indicated in FIG. 1 by two cross-sectional lines of identical vapor density. The vapor density strongly decreases radially from the center of the formation of the vapor cloud toward the outside. The electron beam interacts with the vaporous anode 13, and an interaction zone 12 is formed in the region of overlap.

The X-ray source 1 includes an electric circuit, which may bring the anode supply 15 to a positive potential relative to the electron source 7 during operation. In this example, the anode supply 15 together with the wall of the vapor vessel 25 is at a potential of 0 V, whereas the electron source 7 is at a potential of −100 V. Owing to this potential difference, the emitted electrons are accelerated from the electron source 7 in the direction of the center of the vapor vessel 25 and in the direction of the anode droplets 14. For bundling and focusing the electron beam, the X-ray source 1 also includes a focusing electrode. It is arranged inside the vapor vessel 25 as a cup segment around the interaction zone 12. The evaporated anode material 13 now interacts with the electron beam 11 and is partially ionized thereby. The result is plasma having a high concentration of positive ions, which additionally focus the electron beam in the center of the interaction zone 12. The result for the interaction zone 12 is a somewhat tapered shape, and the focus of the X-ray source becomes narrower. Some of the kinetic energy of the electron beam may now be converted into X-rays 9 owing to the interaction with the vaporous anode material 13. Since the interaction takes place only with a small amount of material, overall only a small proportion of the electrons interact, and only a small proportion of the electron energy is transferred. It is particularly advantageous here that the proportion of resulting characteristic X-rays is high, and only a small proportion of broadband bremsstrahlung is produced. As illustrated in FIG. 1, the X-rays 9 may now be output, for example, in the direction of the electron beam through the beam exit window 5. Outputting them along the local electron beam axis is particularly expedient, since the radiation is spatially focused particularly well in this direction owing to the tapered, necktie-like shape of the interaction zone. The radiation may lie in an angle range a about a central output direction, which angle range may be, for example, up to +/−50 degrees, with particular advantage up to +/−10 degrees.

The vapor vessel 25 may be cooled, using a cooling device, to a temperature of below, (for example, 30 degrees Celsius), such that the evaporated anode material 13 condenses at the walls of the vessel 25. In this way, the continuously fed-in material is also removed continuously from the vapor phase such that a sufficient vacuum may be maintained at least in the region outside the vapor vessel 25.

The electron beam 11 may exit the vapor vessel 25 through the exit opening 27 and impinges in this example on a collector 21, to which an electric potential of −90 kV is applied. On its way to the collector 21, the electrons are decelerated again and, owing to their potential difference, lose approximately 90% of their maximum kinetic energy. They finally impinge on the material of the collector 21 and are captured thereby. With this type of deceleration and capturing, only a very small proportion of bremsstrahlung is formed, which likewise contributes to the monochromatic properties of the X-ray source 1.

In the exemplary embodiment depicted, the central electron flight path 11 is a curved flight path, which is brought about by two deflection units 23 arranged in this case in each case outside the vapor vessel 25. A deflection unit 23 is here arranged between the electron source 7 and the interaction zone 12, and the other deflection unit 23 is arranged between the interaction zone 12 and the collector 21. In this example, the deflection units are two magnetic coils. Alternatively, however, other deflection units may be used, such as for example electrostatic deflection units, and/or further deflection units may be arranged inside the vapor vessel 25. The electron source 7 is arranged in the exemplary embodiment depicted such that it is located with an offset next to a straight connection line between interaction zone 12 and the entry opening 26 of the vapor vessel 25. As a result, the electron source is not exposed to the vapor flow directly exiting through the entry opening 26. By arranging the output device 10 and the beam output window 5 on the side of the exit opening 27 of the vapor vessel 25, the entry opening 25 may also be kept very small, such that the region of the electron source 7 is shielded as well as possible against the vapor flow. Additionally, still further screening elements may be provided to protect the electron source 7 against expanding vapor flow.

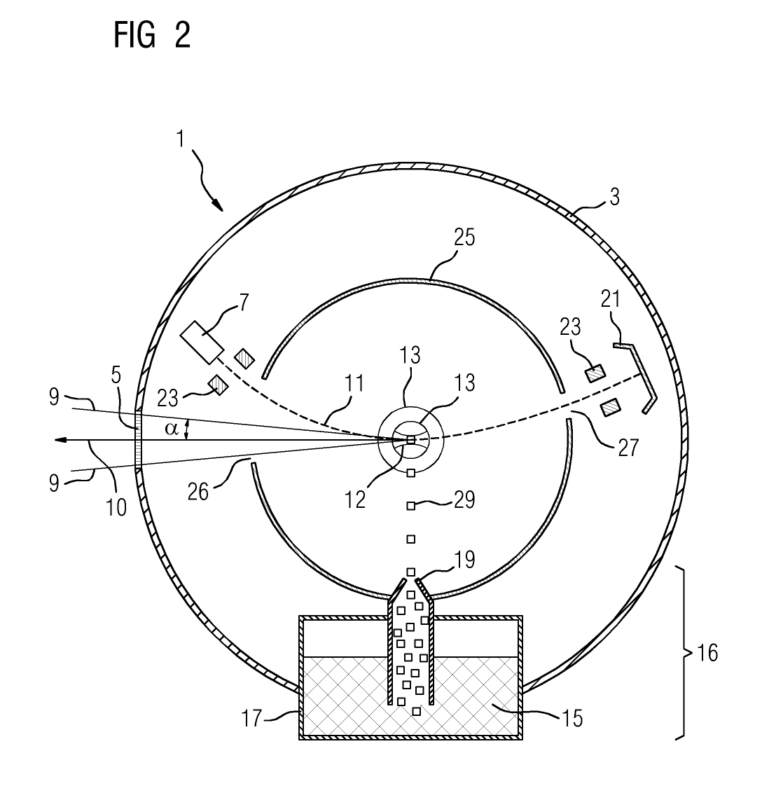

FIG. 2 illustrates a schematic cross section of an X-ray source 1 according to a second exemplary embodiment. In contrast to the first exemplary embodiment, the anode material is fed here into the interior of the vapor vessel 25 in the form of individual solid particles 29. The particles 29 are also fed from a supply container 17 through a nozzle 19. The anode material is present in the supply container 17 in the form of a powder having as homogeneous as possible a particle size. A further difference to the first exemplary embodiment is the arrangement of the beam exit window 5 on the side of the entry opening 26 of the vapor vessel. The output direction 10 of the X-rays 9 is thus oriented in the opposite direction to the local beam direction of the electron beam 11. A rearward output like this has the advantage that in this direction, the ratio of characteristic X-rays to bremsstrahlung is even more favorable than in the forward direction. One difficulty with this geometry, however, is that the entry opening 26 of the vapor vessel 25 is selected to be somewhat larger, depending on the choice of angle range a to be output, than may be necessary merely for inputting the electron beam 11. In this embodiment, additional measures are taken to protect the electron source 7 against the expansion of the vaporous anode material 13. The use of additional protective structures, which are not depicted in this example, to shield the electron source 7 against the vapor flow is thus expedient here.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. An X-ray source comprising:
an outer housing configured to be evacuated, the outer housing comprising at least one radiation exit window that allows X-rays to pass through;
an electron source for emitting an electron beam; and
an anode for producing X-rays,
wherein, when the X-ray source is in operation, the anode is present in a vapor phase,
wherein the vaporous anode is configured to be produced by evaporating a supply of anode material present in a condensed phase by exposing the supply of anode material to the electron beam.

2. The X-ray source of claim 1, further comprising:
a feed apparatus for feeding the anode material present in the condensed phase from the supply of anode material into an interaction zone in a region of the electron beam.

3. The X-ray source of claim 2, wherein the feed apparatus is configured such that the supply of anode material is catapulted into the interaction zone.

4. The X-ray source of claim 3, wherein the supply of anode material is catapulted into the interaction zone in a form of a portioned solid.

5. The X-ray source of claim 3, wherein the supply of anode material is catapulted into the interaction zone in a form of liquid droplets.

6. The X-ray source of claim 1, further comprising:
a vapor vessel, which during the operation of the X-ray source at least partially encloses the vaporous anode, is arranged within the outer housing to be evacuated.

7. The X-ray source of claim 2, wherein the electron source and the supply of anode material are part of an electric circuit, wherein the electron source is configured to be brought to a negative potential relative to the supply of anode material during the operation of the X-ray source.

8. The X-ray source of claim 1, further comprising:
a collector for collecting electrons that pass through the vaporous anode, wherein the collector is configured to be brought to a negative potential relative to the supply of anode material during the operation of the X-ray source.

9. The X-ray source of claim 1, further comprising:
at least one deflection unit for deflecting the electron beam onto a curved electron path.

10. A method for producing X-rays comprising:
forming, continuously, a vaporous anode within an outer housing of an X-ray source that is evacuated by bombarding anode material present in a condensed phase with an electron beam; and
emitting X-rays, by the vaporous anode, due to interaction with the electron beam.

11. The method of claim 10, further comprising:
catapulting the anode material present in the condensed phase into an interaction zone of the electron beam using a feed apparatus.

12. The method of claim 10, further comprising:
feeding the anode material into an interaction zone of the electron beam in a form of a solid in portions.

13. The method as claimed of claim 10, further comprising:
feeding the anode material into an interaction zone of the electron beam in a form of liquid droplets.

14. The method of claim 10, further comprising:
cooling a vapor housing to a temperature of at most 100 degrees Celsius, wherein the vapor housing is located inside the outer housing and at least partially surrounds the vaporous anode.

15. The method of claim 10, further comprising:
decelerating the electron beam after the electron beam passes through the vaporous anode; and
capturing the electron beam by a collector, which is kept at a negative potential relative to the anode material.

16. The X-ray source of claim 2, further comprising:
a vapor vessel, which during the operation of the X-ray source at least partially encloses the vaporous anode, is arranged within the outer housing to be evacuated.

17. The X-ray source of claim 16, further comprising:
a collector for collecting electrons that pass through the vaporous anode, wherein the collector is configured to be brought to a negative potential relative to the supply of anode material during the operation of the X-ray source.

18. The X-ray source of claim 17, further comprising:
at least one deflection unit for deflecting the electron beam onto a curved electron path.

19. The X-ray source of claim 2, further comprising:
a collector for collecting electrons that pass through the vaporous anode, wherein the collector is configured to be brought to a negative potential relative to the supply of anode material during the operation of the X-ray source.

20. The X-ray source of claim 2, further comprising:
at least one deflection unit for deflecting the electron beam onto a curved electron path.
